(19) United States
(12) Patent Application Publication
(10) Pub. No.: US 2008/0266273 A1
(43) Pub. Date: Oct. 30, 2008

(54) INTERACTIVE DISPLAY SYSTEM

(75) Inventors: David Elliott Slobodin, Portland, OR (US); Daniel R. Doyle, Medway, MA (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: White Electronic Designs Corp., Phoenix, AZ (US)

(21) Appl. No.: 12/109,140

(22) Filed: Apr. 24, 2008

Related U.S. Application Data
(60) Provisional application No. 60/926,159, filed on Apr. 24, 2007.

(51) Int. Cl. G06F 3/044; G06F 3/041

(52) U.S. Cl. 345/174; 345/173

(57) ABSTRACT

An interactive display system including a touch sensor overlay having at least one sheet with integrated patterned transparent conductors configured to signal touch data. The interactive display system further including a display assembly and an optical layer interposed the touch sensor overlay and the display assembly.

### CROSS-REFERENCE TO RELATED APPLICATION

The present application claims priority to U.S. Provisional Patent Application Ser. No. 60/926,159 of David Elliott Slobodin and Daniel R. Doyle, entitled INTERACTIVE DISPLAY DEVICE filed Apr. 24, 2007, the disclosure of which is hereby incorporated by reference.

### FIELD

The present application relates to systems, apparatus and methods for interfacing optical layers, and more particularly to systems, apparatus and methods for enhancing an interactive display system.

### BACKGROUND

Interactive displays, such as touch screen displays, enable a display device to be used as both a display and an input device. As an example, touch sensors may be used to enable the interactive display, such as a touch screen display, to accept user input directly on the screen, such as through direct physical contact with a finger or through a stylus or other instrument. Such touch screen displays have been used in a wide variety of environments and can be found on such diverse technology devices from cellular phones, personal data assistants, hand-held computers, personal computers, medical displays, gaming devices, point of sale systems, household appliances, etc. Further, touch screen displays may be found cross-industry, such as incorporated in systems where keyboards and other input device may be less desired, including, but not limited to, museum displays, heavy industry applications, medical applications, high-volume user applications, military applications, etc.

Different types of touch sensors have been used with a variety of display systems. Exemplary touch sensors include, but are not limited to, resistive touch sensors, capacitive touch sensors, surface wave touch sensors, infrared/thermal touch sensors, optical imaging touch sensors, dispersive signal technology touch sensors, acoustic pulse recognition touch sensors, etc. The various types of touch sensors have found popularity due to ease of manufacture and cost. These touch sensors may be added to a display system to convert the display system to an interactive display.

For example, the touch sensor may be layered on the top of a display system, such as a liquid crystal displays (LCDs) or organic light emitting diode displays (OLED). As an example, typical display systems include an OLED or LCD assembly. An LCD assembly may comprise a liquid crystal display panel having a thin film of liquid crystals sandwiched between a pair of transparent electrodes. The LCD cell typically includes a pair of glass plates, the glass plates being sealed together around their respective edges. The glass plates may be assembled with spacers between them to maintain a constant separation distance. Two crossed axis polarizers may be adhered to the respective outside surfaces of the glass sheets, one polarizer being adhered to the front of the liquid crystal display panel and the other polarizer being adhered to the rear of the liquid crystal display panel. When a voltage is applied selectively across the electrodes, the liquid crystal molecules between them may be rearranged or switched in polarization so that light is either transmitted or absorbed in the output polarizer to form characters or graphics. The touch sensors may be layered on top of the display, such as on top of the polarizer. However, the multiple layers required by the touch sensors may significantly affect the optical performance of the display system.

As an example, resistive touch sensors incorporate transparent, electrically conductive layers, which upon touch, may result in a change in the resistance. The resistance change may be processed by a controller to identify the user input. The resistive touch sensors are relatively simple and are generally low cost options. However, such resistive touch sensors may suffer from reduced optical clarity. For example, the various plastic film layers, spacer beads, and ITO (indium tin oxide) layers which comprise many of the resistive touch sensors may result in added diffusion, reflectance and absorption that reduce the brightness and contrast of the displayed image in bright ambient light.

Capacitive touch sensors are another option. Capacitive touch sensors can be generally classified as either surface capacitive or projected capacitive touch sensors. Surface capacitive touch sensors include a uniform transparent conductive layer on a substrate. A uniform, low level electric field is created across the panel by electrodes placed in each corner. When the panel is touched, current is drawn from each corner and a controller can determine the location of the touch by comparing the current flow from each electrode. This type of sensor must be physically touched to generate a signal. A projected capacitive sensor includes a grid of transparent conductors disposed on a substrate. A change in capacitance on the sensor grid is registered when a conductive member, such as a finger or metal stylus, approaches the sensor grid. A controller reads the signals and decodes the touch position information. Unlike the surface capacitance sensors, a projected capacitance sensor can register a touch position even without direct physical contact, enabling an added degree of control (for example hover capability).

As such, some touch screens are dual mode touch screens, allowing both multi-touch and active pen/finger mode operation. See for example, U.S. Pat. No. 6,762,752 entitled Dual Function Input Device And Method issued Jul. 13, 2004, hereby incorporated by reference for all purposes. However, projected capacitive touch sensors suffer in regards to optimal optical performance since typically projected capacitive touch sensors either use transparent conductive coated sheets, such as ITO layers, laminated on plastic or an opaque grid of metal wires sandwiched between glass sheets. The various films used in many of today's projected capacitive touch sensors can introduce haze, and the use of the multiple layers of film bonded together with adhesives all with different indices of refraction may result in undesired reflectance for the display system. For example, in some systems, the PET film haze and the multiple layers of film with different indices of refraction may result in high reflectance, on the order as much as 8-10% reflectance. Further, these sensors are complex and expensive to manufacture.

A polarizing material may be incorporated onto the outer surface of the touch sensor to help control the surface reflections from the touch sensor. For example, a touch sensor polarizer, such as a linear polarizer may be applied to the outer surface of the touch sensor with its pass axis aligned with the output polarizer of the underlying display. The linear polarizer may absorb over 50% of the light incident on the touch sensor, reducing the surface reflections by the same amount, while passing almost all of the light emitted by the underlying display. Further, in some systems, a circular polarizer may be used in conjunction with a quarter wave retarder to further enhance the performance. As such, the retarder is placed between the display output and the touch sensor input and the circular polarizer is placed on the outer surface of the touch sensor. Light emitted from the underlying display passes through the retarder and is rotated from linear to circular polarization. The light passes through the touch sensor and then through the circular polarizer attached to the outer surface and aligned to pass this polarization of light. In this way, only a small amount of light is absorbed in the added layers, reducing the impact on display brightness, Light incident on the surface of the touch sensor may be linearly polarized and then rotated to circular polarization, absorbing over 50% of the incident light. The circularly polarized incident light that passes into the touch sensor may partially reflect off of the various surface interfaces in the touch sensor and display. Since circularly polarized light changes orientation when it reflects (e.g.: transforms from right hand circular to left hand circular upon reflection), the reflected light may be absorbed in the circular polarizer on the reflected path, substantially eliminating internal touch sensor reflections.

However, in touch sensors that incorporate birefringent materials, such as polyethylene terepthalate (PET), the opportunity to improve the optical performance of the display may be limited. This limitation in improving the optically performance may be even more pronounced if a touch sensor polarizer is attached to the outer surface of the touch sensor. When a linear polarizer is used, the birefringent layers pollute the linearly polarized light emitted from the underlying display and some of the desired light may be absorbed by the linear polarizer on the outer surface of the touch sensor, reducing image uniformity. When a circular polarizer is used, similar difficulties occur. Additionally, incident light that is controlled by the circular polarizer is similarly polluted, reducing the effectiveness of the incident light control normally afforded by the circular polarizer.

The inventors herein have recognized that there exists a need for providing improved viewing characteristics for interactive display systems, such as LCDs and OLED displays. Thus, as described in the disclosure below and as illustrated in the example figures, the inventors have provided methods, processes, systems and apparatus for providing an improved interactive display with reduced touch sensor layers.

### SUMMARY

Accordingly, embodiments of methods, apparatus and systems to generate an enhanced layered interactive display system are described herein. In particular, an interactive display system is provided including a touch sensor overlay having at least one sheet with integrated patterned transparent conductors configured to signal touch data, a display assembly, and an optical layer interposed the touch sensor overlay and the display assembly.

### BRIEF DESCRIPTION OF THE FIGURES

FIG. 1 provides a schematic illustration of an interactive display system including a touch sensor overlay and a display assembly.

FIG. 2 provides a schematic illustration of a touch sensor overlay according to an embodiment of the present disclosure.

FIG. 3 provides a schematic illustration of a touch sensor overlay according to another embodiment of the present disclosure.

FIG. 4 provides a schematic illustration of a touch sensor overlay according to another embodiment of the present disclosure.

FIG. 5 provides a schematic illustration of a touch sensor overlay according to another embodiment of the present disclosure.

FIG. 6 provides a schematic illustration of an interactive display system according to an embodiment of the present disclosure.

FIG. 7 provides another exemplary embodiment of an interactive display system according the present disclosure.

FIG. 8 provides another exemplary embodiment of an interactive display system according to the present disclosure.

FIG. 9 provides a flow chart that may be implemented to construct an interactive display system.

### DETAILED DESCRIPTION

It should be appreciated that the following description and corresponding figures provide exemplary embodiments and the methods, applications, processes, and apparatuses are not intended to be limited to such description and figures.

The present disclosure is directed to an interactive display system having a touch sensor overlay. The touch sensor overlay may include a reduced number of layers, compared to, for example, prior capacitive touch sensors. The disclosed touch sensor overlay improves the optical performance of the interactive display system by reducing reflectance within the system, simplifying manufacturing and/or reducing manufacturing costs while retaining the advantages of prior touch sensors, such as prior capacitive touch sensors.

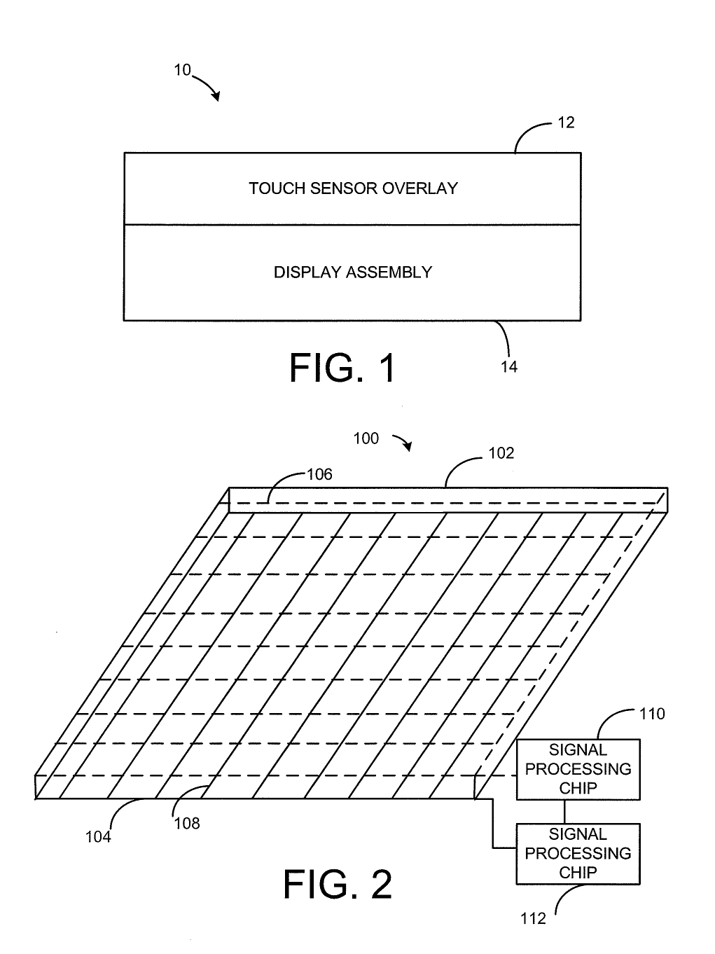

As shown in FIG. 1, an interactive display system 10 includes a touch sensor overlay 12 and a display assembly 14. The display system may be integrated into a variety of devices. For example, and not as a limitation, the display system may be integrated into a cellular phone display, a monitor, a television display, a display for a personal data assistant or other portable computing device, media player, personal media player, outdoors display, industrial display, medical display, automated teller machine (ATM), navigational display, or other electronic presentation, data, or graphic display. As such, although described for example purposes herein as the display system including a display assembly 14, such as an LCD assembly, it should be appreciated that the display system may include any suitable display assembly upon which an overlay may be applied, including, LCDs, organic light-emitting diode (OLEDS), electronic paper (e-paper) displays, surface-conduction electron-emitter displays (SED), light emitting diode (LED) displays, electroluminescent displays (ELDs), etc.

Touch sensor overlay 12 may be at least partially touch sensitive to identify haptic data, such as user touch input. The overlay may be a substantially transparent layer coupled to the outer face of the display assembly 14 as an interface between the display and the viewer. The overlay may be any suitable transparent material, including tempered glass or transparent plastic. Such an overlay may provide a touch interface and may provide desired aesthetic features to the display. For example, some overlays may be used to create a smooth, transparent cover over the display, as in a cell phone, computer monitor or television. Further, some overlays may improve the durability of a fragile display assembly, such as an LCD or OLED. The overlay may further provide mechanical and/or environmental protection in displays which are stressed by their environments, including displays with high use levels, e.g, displays in public kiosks or ATMs, or displays where the input device is a pen or stylus. The overlay may operate to protect the soft, polymeric top polarizer on the LCD or may protect the films and materials within the OLED. Moreover, the overlay may include optical display enhancing features, including, but not limited to EMI shielding.

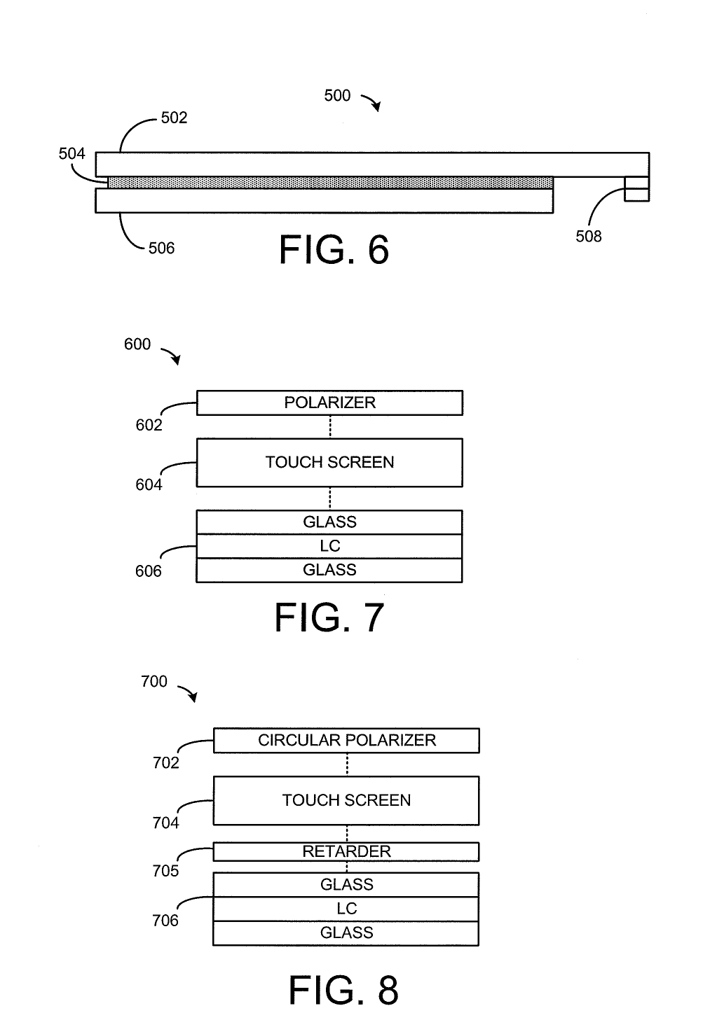

FIG. 2 provides a schematic illustration of a non-limiting example embodiment of a touch sensor overlay 100 configured to detect haptic data for an interactive display system. Touch sensor overlay 100 may be a single transparent sheet, such as a glass sheet, which may be configured to be disposed or bonded to a display assembly (as illustrated in FIG. 6).

There are various types of touch sensors, including, but not limited to resistive touch sensors, capacitive touch sensors, including surface capacitive and projected capacitive touch sensors. As shown, touch sensor overlay may be a capacitive overlay. Although described as a capacitive overlay, it should be appreciated that the touch sensor overlay may by any other suitable touch sensor.

Touch sensor overlay 100 may include a first surface 102 and an opposing surface 104. Transparent conductors may be patterned on each surface, such as along an x-y coordinate axis to form a grid. For example, first surface 102 may have x-electrodes 106 integrally patterned thereon, and opposing surface 104 may include y-electrodes 108 integrally patterned thereon, or vice versa. As such, the electrodes are illustrated in what may be considered a complementary pattern. Although the x-electrodes and y-electrodes are shown in a perpendicular complementary arrangement in an x-y coordinate axis system, any suitable configuration may be provided such that the conductors are integrally patterned into the overlay. As one example, the electrodes may be positioned diagonally across the sheet. Such electrodes may be in a complementary pattern. Further, in some embodiments the conductors may be layered such that they have different indices of refraction such that the overlay has anti-reflective properties.

Moreover, although shown where the electrodes are integrated on opposing surfaces, it should be appreciated that in some embodiments, a single layer of patterned transparent conductors may be integrated on a single side of a glass sheet or through the glass sheet. Yet in other embodiments, the x-electrodes and y-electrodes may be translucent and/or located on separate glass sheets spaced apart.

The patterned electrodes, 106 and 108 may be coupled to one or more signal processing chips 110, 112 to enable detection of touch interaction. Although two signal processing chips are illustrated, it should be appreciated that in some embodiments, a single processing chip or more than two signal processing chips may be employed.

The touch sensor overlay of FIG. 2 reduces design complexities and manufacturing costs as the capacitive overlay may be a single glass sheet. Further, in contrast to known systems which employ a multi-layered approach, such as a layer of film plastic, such as a PET plastic layer, an ITO layer, an adhesive layer, another PET layer, another adhesive layer, etc., the disclosed system minimizes the number of layers, and thus, reduces the number of optically disruptive layer interfaces. Moreover, by providing a single layer touch sensor overlay it is possible to optically match the overlay to the display assembly coupling surface to further enhance the optical characteristics of the interactive display system. For example, the overlay may have an index of refraction which is substantially similar to the external surface of the display assembly. The conductors similarly may be transparent with a similar index of refraction such that any disruption in the image display is minimized or substantially eliminated.

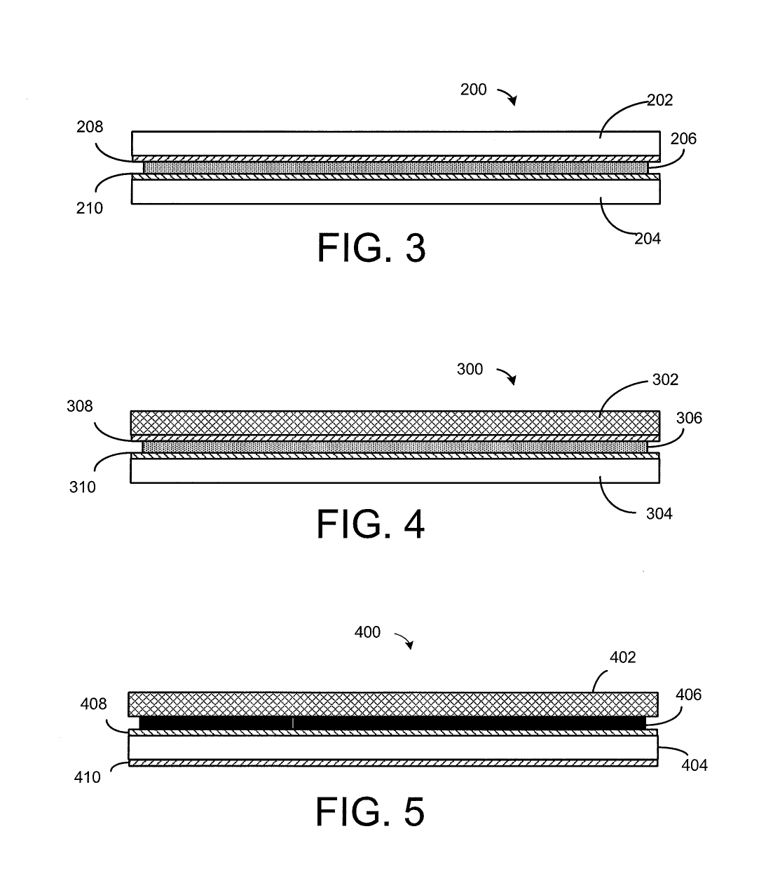

FIGS. 3-5 provide additional example illustrations of touch sensor overlays for an interactive display system. As shown in the examples, an interactive display system is provided including a touch sensor overlay including at least one sheet having integrated patterned transparent conductors configured to signal touch data. The touch sensor overlay may be coupled or bonded to a display assembly as described in more detail below. The at least one sheet of the touch sensor overlay may include a first side and an opposing side, where a first set of conductors is on the first side and a second set of complementary conductors are on the opposing side. The conductors may be in a grid pattern. Further, in some embodiments, the touch sensor overlay includes a first sheet with a first set of conductors and a second sheet with a second set of conductors. The sheets may be a glass sheet or a polymer film sheet. As such, the first sheet may be optically bonded with a touch sensor overlay optical adhesive to the second sheet. The touch sensor overlay optical adhesive may have a refractive index substantially similar to one of the first sheet and the second sheet.

Referring more specifically to FIG. 3, touch sensor overlay 100 may include two optically bonded glass sheets 202, 204, each with patterned conductors, such as electrodes, integrated into the glass sheets. For example, each sheet may have patterned ITO on one side of each sheet. For example, first sheet 202 may include a patterned electrode surface 208 and second sheet 204 may include a patterned electrode surface 210.

In some embodiments, an optical layer 206 may be disposed between first sheet 202 and second sheet 204. The optical layer 206 may be optically matched to one or both of the first and second sheets. In some examples, optical layer 206 may be an optical adhesive similar to an optical adhesive used to physically adhere the touch sensor overlay 200 to a display assembly as described in regards to FIG. 6. As an example, an optical adhesive may be a solid, gel or liquid and may have an index of refraction that is similar or substantially matched to the index of refraction of one or both of the two sheets of the touch sensor overlay. The optical layer may further be optically matched with the outermost surface of the display assembly. For example, and not as a limitation, the external surface of the display assembly or the overlay may be glass and have an index of refraction of 1.472 such that the optical adhesive may similarly have an index of refraction of 1.406.

In some embodiments, the touch sensor overlay may further have additional film coatings or laminates, such as hardcoat films, anti-reflection film, anti-glare film, anti-smudge film and/or anti-fingerprint film disposed on the surface opposite the side with the transparent conductor. These films may be integrated into the surface of the overlay or may be an additional layer on the surface of the overlay. The additional films may enhance the optical performance of the interactive display system and the mechanical properties of the interactive display system.

FIG. 4 provides another schematic illustration of a non-limiting exemplary embodiment of a touch sensor overlay 300 for an interactive display system. As described above, in some embodiments, the touch sensor overlay may be optically bonded to a display assembly forming an interactive display system. However, optical bonding is not required. As an example, and not as a limitation, an optical adhesive may be used to physically adhere touch sensor overlay 300 to an external surface of an LCD assembly. The optical adhesive may be a solid, gel or liquid and may have an index of refraction which is similar or substantially matched to the index of refraction of the surface layer of the LCD and/or the exposed contact surface of the capacitive overlay.

Touch sensor overlay 300 may include two optically bonded sheets: a polymer film sheet 302 and a glass sheet 304, with patterned conductors, such as patterned ITO, on each sheet. The touch sensor overlay may be a light weight construction overlay due to the use of the polymer sheet. For example, first sheet 302 may include a patterned electrode surface 308 and second sheet 304 may include a patterned electrode surface 310. In some embodiments, an optical layer 306 may be disposed between polymer film 302 and glass sheet 304. In some examples, optical layer 306 may have an index of refraction similar to the index of refraction of the overlay sheets and/or the outermost layer of the display assembly. The optical layer may be an optical adhesive and may be similar to the optical adhesive used to bond the touch sensor overlay to a display assembly.

Polymer film sheet 302 may or may not have birefringent properties. Further, polymer film 302 may be a polarizing film or include a polarizing film laminate. In some embodiments, polymer film 302 may be considered a polarizer sheet. In such embodiments, a transparent conductor may be applied to the polarizer sheet and patterned to form the top layer of the polymer/glass touch sensor overlay. Furthermore, the polymer film 302 may have integrated or layered films, including, one or more of the following: hardcoat films, anti-reflection films, anti-glare films, anti-smudge films and/or anti-fingerprint films disposed on the surface opposite the side with the transparent conductor. The additional films may enhance the optical performance of the interactive display system and the mechanical properties of the interactive display system.

FIG. 5 provides another schematic illustration of a non-limiting exemplary embodiment of a touch sensor overlay 400 for an interactive display system. The touch sensor overlay may include a first sheet 402 and a second sheet 404, where each sheet may be a glass or polymer film sheet. As illustrated, the first sheet 402 may be tempered glass or a polymer and may or may not have birefringent properties. In other examples the first sheet 402 may be constructed out of other suitable transparent or partially transparent materials. The second sheet 404 may include a first and second patterned electrode surface, 408 and 410 respectively. In some examples, the first and second patterned electrode surfaces, 408 and 410, may be patterned ITO. In other examples, the patterned electrode surface may include another capacitive and transparent, or partially transparent, material.

An optical layer 406 may be provided between first sheet 402 and second sheet 404. The optical layer may have an index of refraction which is similar or substantially similar to one or more of the first sheet 402, the second sheet 304 and/or the outermost layer of the display assembly. The optical layer 406 may be an optical adhesive to bond the first sheet 402 and second sheet 404.

Each of the above overlays may be coupled to a display assembly to form an interactive display system. FIG. 6 illustrates a cross-sectional view of an interactive display system 500. In the schematic illustration, interactive display system 500, includes a touch sensor overlay 502, an optical layer 504 and a display assembly 506. Touch sensor overlay may include one or more sheets with integrated patterned conductors such as the example touch sensor overlays described in FIGS. 2-5. The display assembly may be any suitable display assembly, including, but not limited to and LCD display assembly, an LED display assembly, an OLED display assembly, an e-paper display assembly, a SED assembly, an ELD assembly, etc.

As an example, an LCD assembly may include a layer of liquid crystal disposed between two transparent electrodes, and two polarizing filters, the axes of polarity of which are perpendicular to each other. Selectively applying a voltage to the electrodes (and the resultant configuration change of the liquid crystals) enables control of whether light is either transmitted or absorbed such that images may be formed on the LCD. Additional information regarding LCDs may be found in U.S. Pat. No. 6,933,991 entitled Super Bright Low Reflectance liquid Crystal Display issued Aug. 23, 2005 and U.S. Pat. No. 6,181,394 entitled Super Bright Low Reflectance Liquid Crystal Display issued Jan. 30, 2001, both of which are hereby incorporated by reference for all purposes.

The display assembly may be coupled to the touch sensor overlay using through an adhesive, through a mechanical frame, or through any other suitable coupling mechanism. In systems which are bonded, optical layer 504 may be an optical adhesive. The optical layer, or in embodiments where the optical layer is an optical adhesive, the optical adhesive, may be an index-matched material such that the indices of refraction are substantially similar to one or both of the outermost surface of the display assembly and/or the facing surface of the sensor sheet.

The optical adhesive may be a solid, gel or liquid. In some examples, the optical adhesive may be a combination adhesive which is considered in application as a procured optical adhesive. For example, the bonding material may be applied as a liquid adhesive, also referred to as an optical bonding liquid, to one or both of the overlay or the external surface of the display assembly. The optical bonding liquid may be fully or substantially cured to form an adhesive preform, and following curing, the second substrate, may be laminated onto the display. Post processing may be used in some embodiments to increase the adhesion strength of the bond and drive any entrapped air from the bond.

As an example and not as a limitation, the optical adhesive may be a silicone-based bonding material. For example, the adhesive may be a two-part cured silicone adhesive. Alternatively, the optical adhesive may be other suitable materials, including, but not limited to, urethane derivative materials and/or acrylic derivative materials. In some embodiments, the optical adhesive may be a mixture of a urethane derivative and a silicone derivative (and/or acrylic derivative). The mixture of the harder urethane-derivative with the softer silicone-derivative may provide additional bonding characteristics. As another example, in some embodiments, bonding to glass may be with a urethane-derivative, and/or bonding to the display may be with a silicone-derivative. Further, in some embodiments, it may be possible to use an epoxy derivative.

As further examples, and not as limitations, the following optical adhesives are provided as illustrative example optical adhesives and may be used alone or in combination. Options for optical adhesives, include gels, elastomers and resins, including but not limited to, a mixture of dimethyl-siloxane and vinyl terminated dimethyl polymer with a hydrosilane crosslinking agent, a mixture of dimethyvinylsiloxy-terminated phenylmethyl cyclosiloxanes, methylvinyl siloxane, dimethoxy (glycidoxypropyl)-terminated, and/or polyether based aliphatic polyurethane.

In other embodiments, a multi-layer approach may include use of acrylic optically clear adhesives. Further a thinner may be applied to decrease the viscosity to the optical adhesive and assist in lamination. A material with a drying rate similar to acetone may be used such as hexamethyldisiloxane to achieve these effects. It should be appreciated that the optical adhesive may be selected based on a plurality of factors, including but not limited to: optical qualities, such as the index of refraction of the material, and mechanical qualities, including bonding characteristics and curing speed.

The sandwich formed by the touch sensor overlay, the optical layer and the display assembly form an interactive display assembly. One or more signal processing chips 508 may be communicatively coupled to the touch sensor overlay to enable the touch detection functions of the interactive display system. The signal processing chips may be electronically coupled to a computing device (not shown), allowing haptic data from the overlay to be interpreted. In some examples the signal processing chips may wirelessly communicate with the computing device.

It should be noted that touch sensor overlay may have additional properties to improve performance of the interactive display. For example, the touch sensor overlay may have films, including integrated films, layers or coatings, which provide display enhancing features, including anti-reflective enhancements, anti-glare enhancements, anti-smudge enhancements, anti-fingerprint enhancements, etc. Moreover, portions of the overlay may be specially treated depending on the use environment to accommodate accessories or for aesthetic purposes. For example, sensors, actuators or other components may be bonded to the touch sensor overlay. Further sections of the overlay may be etched or painted.

In contrast to prior systems where optical performance was compromised due the use of multiple layers having different indices of refraction, including PET plastic film layers, adhesives layers and ITO layers mounted on glass, in the present disclosure the touch sensor overlay, and associated layers, have indices of refraction which are matched or correlated, or film thicknesses optimized, to improve optical characteristics of the interactive display system. The matching of the indices of refraction, or optimizing the film thicknesses, may reduce the reflectance enabling the interactive display system to have anti-reflective properties, such that the layers may be considered anti-reflective layers or coatings. Additionally, in some embodiments, some layers may exhibit birefringence, limiting polarization control and reducing the effectiveness of polarization-based incident light reflection control.

FIG. 7 provides another schematic illustration of an exemplary interactive display system 600. Interactive display system 600 may include an external polarizer 602, a touch sensor overlay 604, and a display assembly 606. In this example, the display assembly is an LCD assembly. However, in other examples another suitable display assembly may be used. Use of the polarizer in combination with the touch sensor overlay described above may effectively reduce reflections and improve the optical characteristics of the interactive display system. Further, the external polarizer and system design may result in improved ruggedness for the interactive display system. By using the polarizer on the outer surface of the capacitive overlay as the output polarizer of the underlying interactive display system, functional redundancies can be eliminated reducing cost and complexity. For example, the exit polarizer of the interactive display system (normally adhered to the viewing surface of the LCD) may not be required if an external polarizer is used. This may apply in the case where the capacitive overlay does not significantly alter the polarization state of the light emerging from the LCD and transmitting through the touch sensor overlay. In some examples, the LCD may further include a backlight enhancing viewing capabilities, a bezel providing structural support, and various other features.

FIG. 8 provides another schematic illustration of an exemplary interactive display system 700. Interactive display system 700 may include an external circular polarizer 702, a touch sensor overlay 704, a quarter wave retarder 705 and a display assembly 706. In this example, the display assembly is an LCD assembly, but as described above, other suitable display assemblies may be used. Use of the circular polarizer and quarter wave retarder in combination with the touch sensor overlay described above effectively reduces reflections and improves the optical characteristics of the interactive display system. By using the polarizer on the outer surface of the touch sensor overlay as the output polarizer of the underlying display, functional redundancies can be eliminated reducing cost and complexity. As there are fewer layers within the interactive display system, optical performance may again be enhanced. For example, the exit polarizer of the LCD (normally adhered to the viewing surface of the LCD) may not be required if an external polarizer is used as shown in FIG. 7. This only applies in the case where the capacitive overlay does not significantly alter the polarization state of the light emerging from the LCD and transmitting through the capacitive overlay. Therefore, if the two layer polymer/glass capacitive overlay described in the embodiment illustrated in 4 were used in the FIG. 8 configuration and the LCD exit polarizer is not used, a non-birefringent polymer film may be required in the touch sensor overlay. Example non-birefringent polymers may include, but are not limited to, triacetate cellulose, COC, polyurethanes, acrylic siloxanes and silicones.

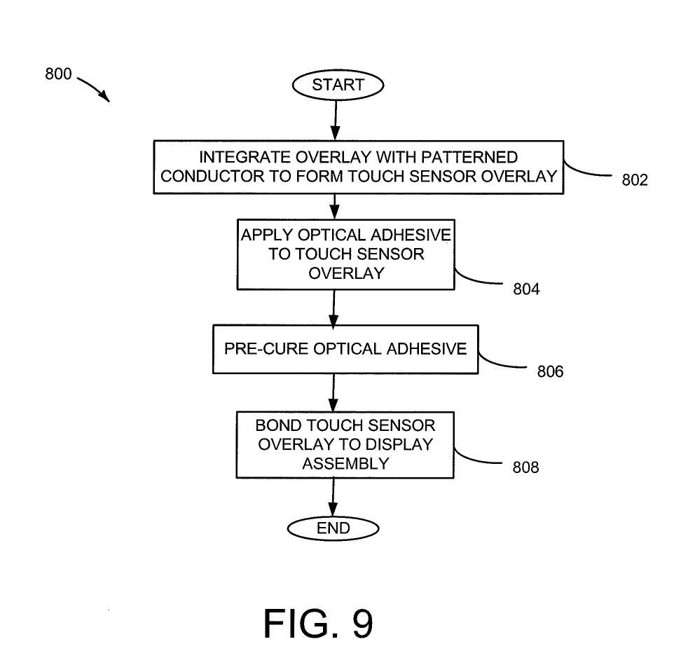

FIG. 9 shows a flow chart, method 800, detailing a construction method for an interactive display system. In this example, a capacitive touch sensor overlay is utilized in the construction of the interactive display system, allowing the interactive display system to have touch sensitive capabilities. Touch sensitive capabilities may include the ability of the system to detect a change in capacitance of the capacitive overlay. The interactive display system may be constructed in such a way to reduce the number of layers in the interactive display system in order to reduce manufacturing costs and complexities, enhance the optics, as well as increase the aesthetic appeal of the interactive display system. In some examples, the constructed interactive display system may be similar to the display system shown in FIG. 6, including a touch sensor overlay, an optical layer and a display assembly. In other examples, method 800 may be used to construct another suitable display system.

First at step 802, an overlay may be integrated with a patterned conductor to form a touch sensor overlay. For example, ITO may be integrated onto at least one sheet included in an overlay. Integrating the ITO into the overlay allows the overlay to have capacitive touch sensitive capabilities. The sheet may be a glass sheet or polymer sheet. A layer of patterned ITO may be applied to one or more sides of a sheet allowing the ITO to be integrated. The ITO may be deposited by methods such as electron beam evaporation or a range of sputtering techniques. In other examples, alternate or additional suitable techniques may be used to integrate the ITO into the capacitive overlay, such as periodic pulses of ITO spray. In other examples, another suitable capacitive material may be used such as a carbon nano-tube capacitive coating, aluminium-doped zinc oxide, and/or various others. Further, it should be appreciated that integrating a patterned transparent capacitive material may include optically bonding a first sheet and a second sheet. The sheets may have complementary sets of integrated conductors. In some embodiments, the conductors may be layered with different indices of refraction for anti-reflective purposes.

In some embodiments, where more than one sheet is used in the touch sensor overlay, an optical layer may be provided that has a similar refractive index to the other layer. The optical layer may be an optically adhesive as described above.

At step 804, an optical adhesive may be applied to the touch sensor overlay. In some examples, the optical adhesive may be a transparent adhesive with a similar refractive index to one or more sections or layers of the display assembly and/or overlay, as discussed above. In this example, the optical adhesive may have a similar refractive index to the overlay sheets and/or the external surface of the display assembly. In other examples, the optical adhesive may be applied to the display assembly. In some embodiments, the optical adhesive may be precured as indicated at 806. Pre-curing may include, heating the display and/or optical adhesive to a predetermined temperature, applying a light to the adhesive, and/or waiting for a period of time which may be predetermined.

Next at step 808, the touch sensor overlay may be bonded to a surface layer of a display assembly. Bonding may include aligning and bringing the touch sensor overlay into contact with the display assembly. In some embodiments, pressure, heat, etc. may be applied to bond the touch sensor overlay with the display assembly to form an interactive display system.

It should be appreciated that the above disclosed capacitive overlay may be used in any suitable interactive display system, including without limitation use in a dual mode interactive display system.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Submitted or amended claims, whether they are directed to a different invention or directed to the same invention, whether different, broader, narrower or equal in scope to any original claims, are also regarded as included within the subject matter of the inventions of the present disclosure.

We claim:

1. An interactive display system comprising:
a touch sensor overlay including at least one sheet having integrated patterned transparent conductors configured to signal touch data;
a display assembly; and
an optical layer interposed the touch sensor overlay and the display assembly.

2. The interactive display system of claim 1 wherein the display is one of a liquid crystal display, an organic light emitting diode display, and an electronic paper display.

3. The interactive display system of claim 1, wherein at least one sheet of the touch sensor overlay includes a first side and an opposing side, where a first set of conductors is on the first side and a second set of complementary conductors are on the opposing side.

4. The interactive display system of claim 1, wherein the conductors are in a grid pattern.

5. The interactive display system of claim 1, wherein the touch sensor overlay includes a first sheet with a first set of conductors and a second sheet with a second set of conductors.

6. The interactive display system of claim 5, wherein the first sheet is optically bonded with a touch sensor overlay optical adhesive to the second sheet.

7. The interactive display system of claim 6, wherein the touch sensor overlay optical adhesive has a refractive index substantially similar to one of the first sheet and the second sheet.

8. The interactive display system of claim 1, wherein the at least one sheet is one of a glass sheet and a polymer film sheet.

9. The interactive display system of claim 1, wherein the optical layer includes an optical adhesive bonding at least one portion of the display assembly to the touch sensor overlay, where the optical adhesive has a refractive index substantially similar to one of the at least one optical sheet of the touch sensor overlay and to an exterior coupling surface of the display assembly.

10. The interactive display system of claim 1, wherein the conductors are indium tin oxide.

11. The interactive display system of claim 1, further comprising a circular polarizer coupled to the touch sensor overlay.

12. The interactive display system of claim 1, further comprising a quarter wave retarder disposed between the display assembly and the touch sensor overlay.

13. An interactive display system comprising:
a display assembly;
a transparent capacitive touch sensor overlay with a first sheet with integrated electrodes bonded to a second sheet with an touch sensor overlay optical adhesive where the touch sensor overlay optical adhesive has a refractive index substantially similar to one of the first sheet and the second sheet;
a optical layer interposed the display assembly and the touch sensor overlay; and
at least one signal processing chip electronically coupled to the touch sensor overlay.

14. The interactive display system of claim 13, wherein the integrated electrodes is patterned indium tin oxide.

15. The interactive display system of claim 13, wherein the first sheet is a glass sheet and the second sheet is a polymer film sheet.

16. The interactive display system of claim 13, wherein the second sheet includes a second set of integrated electrodes.

17. The interactive display system of claim 13, wherein the optical layer has an index of refraction substantially similar to an exterior surface of the display assembly.

18. A method for construction of an interactive display system comprising:
integrating a patterned transparent capacitive material on one or more sheets to form a touch sensor overlay; and
bonding the touch sensor overlay to a display assembly.

19. The method of claim 18, further comprising, prior to bonding the touch sensor overlay, applying an optical adhesive to one of the touch sensor overlay and the display assembly; and pre-curing the optical adhesive.

20. The method of claim 18, wherein integrating a patterned transparent capacitive material including optically bonding a first sheet and a second sheet.

21. The method of claim 18, wherein integrating a patterned transparent capacitive material includes layering of conductors of different indices of refraction for anti-reflective purposes.
